(19) United States
(12) Patent Application Publication
(10) Pub. No.: US 2007/0277565 A1
(43) Pub. Date: Dec. 6, 2007

(54) Apparatus and Method for Processing Fur

(76) Inventor: Borge Vind, Olgod (DK)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/586,301

(22) PCT Filed: Jan. 14, 2005
(86) PCT No.: PCT/DK05/00018

§ 371 Date: Jun. 27, 2007

(30) Foreign Application Priority Data
Jan. 14, 2004 (DK) PA 2004 00033

(51) Int. Cl. C14B 1/10

(52) U.S. Cl. 69/42; 69/22; 69/23

(57) ABSTRACT

An apparatus (1) and method for processing fur, including a number of mandrels (2) and at least one motor-driven scraping roller (6), where the fur is disposed on the mandrel (2) with an inner side facing outwards, where the apparatus (1) includes an motor system (8) with a number of fixing means (5) that are adapted for holding a lower end part of the mandrels (2) which are disposed at an upright angle relative to the fixing means (5), the motor system adapted for moving the mandrels (2) past a number of processing positions.

A fur is placed on a mandrel (2) with an inner side facing outwards in a preferably first processing position; where a motor system (8) moves the mandrel (2) to a second procession position; where the scraping unit (4) is lowered down over the mandrel (2) and is moved downwards along its outer side whereby remains of fat and flesh are scraped off; where the motor system (8) moves the mandrel (2) further to a third processing position where the cleaning unit is lowered down over the mandrel (2) and is moved downwards along its outer side whereby the fur is cleaned and sawdust with residual fat is sucked away; where the motor system (8) moves the mandrel (2) further to a fourth processing position where the combined removing and turning unit holds a pointed end of the fur while a suction chamber simultaneously provide for turning the fur; and where the motor system (8) moves the mandrel (2) on to a next processing position which is preferably constituted by the first processing position.

### FIELD OF THE INVENTION

The present invention concerns an apparatus for processing fur, including a number of mandrels and at least one motor-driven scraping roller, where the fur is disposed on the mandrel with an inner side facing outwards.

The invention furthermore concerns a method for processing fur by means of the above apparatus including a number of mandrels and a number of processing positions.

### BACKGROUND OF THE INVENTION

The fur industry is subjected to the same economic rules as other industries that try to earn money on their products. This means that they are to reduce the costs of production in order to maximise the revenue on the product.

A reduction in production costs may be attained by e.g.:
reducing the time used for producing the product;
simplifying the production process; and/or
automating the production process.

In the fur industry, great savings may be achieved if the time consumed for fur treatment processes is reduced simultaneously with simplifying the fur processes.

After a fur-bearing animal has been killed and skinned, the fur is disposed on a mandrel with the inner side facing out, whereafter remains of fat and flesh are scraped off in a subsequent scraping process, so that the furs may be finished and achieve a quality providing the best price on a fur auction.

There are different types of scraping machines which can scrape fat and flesh residues off the inner side of the fur. For example, there are scraping apparatuses, where:
mandrels with rectangular cross-section are used;
mandrels with circular cross-section are used;
the mandrel is disposed horizontally during the scraping process;
1-4 scraping rollers are applied during the scraping process.

In order to ensure efficient scraping of the fur, the scraping apparatus using mandrels with a rectangular cross-section is designed with two sets of mutually displaced scraping rollers, providing that the scraping of the inner side of the fur is performed in one movement by the two sets of scraper wheels along the mandrel.

A mandrel with fur is disposed horizontally in a scraping apparatus so that the mandrel is moved from a mounting position to a scraping position. In order to guard the scraping process, screens are disposed between the mounting position and the scraping position, guarding as well as guiding the mandrel during the scraping process.

Even if the scraping rollers scrape off excess fat and flesh residues from the inner side of the fur, and the scraped off material is conveyed with the scraping rollers and sucked away, a slight accumulation of residual fat will occur anyway in the area of the mandrel where the scraping of the fur is stopped.

The disadvantage of a scraping apparatus with horizontal mandrels is that when the mandrel is drawn back from the scraping position to the mounting position, the screen will draw the residual fat accumulation back along the mandrel so that the entire mandrel is smeared with residual fat, making it difficult to handle the mandrel.

The mandrels are therefore cleaned before they can be used again, thus increasing the time consumption of the scraping process.

In order to minimise this extra consumption of time, a prior art scraping apparatus is provided with a washing unit through which the mandrel is drawn after the fur has been scraped and removed from the mandrel. The washing unit uses either hot water or water with chemicals for dissolving the fat, so that the mandrel is clean and ready for repeated used.

However, there is a drawback of using a wash section, since this is either to be permanently connected to a water supply, or it has to be designed with a number of liquid containers for pure and used liquid. This implies that the scraping facility becomes complicated and more expensive in procurement as well as in operation.

Possible fat-dissolving and/or septic chemical used in the liquid may be detrimental to the fur, if a clean mandrel with chemical residues is applied to a fur with the fur side facing the mandrel. The chemical residues may possibly cause bleaching or holes in the fur, whereby the value of the fur, in the worst case, is considerably reduced.

In order to reduce the time consumption for the scraping process, a prior art apparatus is designed so that a number of mandrels may be disposed in a rotating arrangement, so that a fur is mounted manually on a mandrel while a fur on another mandrel is scraped, whereby the scraping rollers are kept running with scraping furs all the time, thus reducing the time for the scraping process of a single fur, but the capacity is, of course, determined to the extent with which the manual mounting of fur on the other mandrel can keep up with the scraping process.

### OBJECT OF THE INVENTION

The purpose of the present invention is to indicate an apparatus that may perform one or more approximately automated and different treatments on a fur.

This is achieved with an apparatus as specified in the preamble of claim 1, and where it includes a motor system with a number of fixing means that are adapted for holding a lower end part of the mandrels which are disposed at an upright angle relative to the fixing means, the motor system adapted for moving the mandrels past a number of processing positions.

A further object of the present invention is to indicate a method for processing furs at a number of processing positions.

This is achieved with a method of the kind specified in the preamble of claim 15, and where a fur is placed on a mandrel with an inner side facing outwards in a preferably first processing position; where a motor system moves the mandrel to a second procession position; where the scraping unit is lowered down over the mandrel and is moved downwards along its outer side whereby remains of fat and flesh are scraped off; where the motor system moves the mandrel further to a third processing position where the cleaning unit is lowered down over the mandrel and is moved downwards along its outer side whereby the fur is cleaned and sawdust with residual fat is sucked away; where the motor system moves the mandrel further to a fourth processing position where the combined removing and turning unit holds a pointed end of the fur while a suction chamber simultaneously provide for turning the fur; and where the motor system moves the mandrel on to a next processing position, preferably the first processing position.

### SUMMARY OF THE INVENTION

In order to scrape a fur on the inner side of the fur, the fur-bearing animals are put down and skinned so that they then lie with the inner side of the fur facing outwards. In order to scrape the furs, the furs are to be disposed on a mandrel which is pressed into the furs so that the fur side of the furs envelopes the mandrel.

Scraping rollers are disposed in a processing position so that they envelope the mandrels, whereby the scraping rollers are moved down along the mandrel and scrape the fur clean on two opposing sides of the mandrels.

This is a necessary treating process which is performed for avoiding rotting of the fur and is effected by the scraping rollers treating one fur at a time, after which the fur is taken off the mandrel and a new fur is put on the mandrel, so that the scraping rollers may process the next fur.

In order to increase the speed of the scraping process, an apparatus as described in the present invention is used, where the apparatus includes a plurality of mandrels, so that a fur provided on a mandrel may be scraped at the same time as another fur is put on another mandrel; and the apparatus furthermore includes up to a plurality of processing positions that may be used for e.g. mounting other furs on mandrels; and the apparatus may include rotor-driven scraping rollers so that the apparatus can scrape more than one fur at a time. In that way, the speed of the scraping process may be increased.

An alternative to this is that the processing positions, instead of being used for extra mandrels and extra mounting of fur, are used for other kinds of fur treatment, e.g. a processing position where the fur is taken off the mandrels and turned, whereafter the fur is ready for e.g. putting on a pelting board.

In case that the apparatus is mounted with a plurality of different mandrels, where these mandrels are to move past a number of processing positions, the apparatus furthermore includes a motor system with a number of fixing means, where these fixing means are adapted to secure a lower end part of the mandrels.

In that way, the mandrels will stand in an upright angle in relation to the fixing means secured on the motor system. This means that the furs are to be placed on the mandrel from above and downwards, which is the easiest way to put on a fur on a mandrel.

The motor system is made so that it either may move the mandrels continuously past the processing positions, or may move the mandrel past the processing position in steps where the various fur processes are performed, after which the motor system moves the mandrel on to a next processing position.

The fixing means for connecting the mandrels to the motor system are e.g. small plates that have the same cross-sectional area as the lower end part of the mandrel, so that the mandrel fits directly onto the fixing means and may thereby be held in a secure position.

The fixing means may be fixed to the motor system so that the fixing means with the mandrel will have a certain position irrespectively how the motor system moves the mandrels from processing position to processing position.

In an embodiment of the invention, the motor system is constituted by a rotatable, preferably ring-shaped surface, on which a number of the fixing means are provided.

Hereby is achieved that the mandrels with associated fixing means disposed upon the rotatable ring-shaped surface will be moved from a processing position to the next processing station, either continuously or in steps, when the motor system turns the ring-shaped surface.

The advancing of the preferably ring-shaped surface occurs by means of a motor so that the motor is activated from a control causing activation of the motor turning the ring-shaped surface, e.g. every third or sixth second.

The motor may be coupled to the ring surface, either by means of gear wheels, drive belt, chain or similar, or by direct shaft transmission to the ring-shaped surface. The type of connection used entirely depends on how large the rotatable ring-shaped surface is, and on how many fixing means there are placed on the surface.

In a second embodiment of the invention, the motor system is constituted by a transport chain on which the fixing means are disposed, and on which mandrels are disposed.

The conveyor chain is pulled around in a rail or a guide that guides the mandrels from processing position to processing position.

It will be possible to establish plural fixing means on the conveyor chain, depending on how many mandrels are wanted in the apparatus.

Furthermore, this embodiment will entail that it is possible to transport mandrels over longer distances, so that it is not necessary to mount the fur on the mandrel right up to the scraping process, or that subsequent processing positions are in the immediate vicinity physically.

The conveyor chain may be a common segmented chain, or be a wire or belt or similar. The detail to be ensured is that the conveyor chain will be so flexible, either by the segments or in the material itself. that it may follow the rail/guide, irrespectively if there is a curve or a straight section on the rail/guide, and that it is possible to fasten fixing means on the conveyor chain.

A further degree of freedom to how the fur mounting and mandrels may be disposed is that the mandrels are rotatably fastened to the fixing means.

I.e. the mandrels may be turned around arbitrarily, so that a person putting fur on may achieve the best possible ergonomic mounting of the fur.

This may not be a drawback when the mandrels with fur applied thereon arrive at a subsequent processing position, e.g. for the scraping rollers, where the scraping rollers will guide the mandrels automatically to the desired position when the scraping is commenced.

After mounting the fur on the mandrel, it is advanced to a first processing position that includes at least one scraping unit with scraping rollers.

In a preferred embodiment, the scraping unit includes two scraping rollers which are disposed opposite each other, so that they during use enclose the mandrels and scrape the flesh side of the fur clean at both sides of the mandrels.

A protective jacket is provided in connection with the scraping unit, providing that scraped off fat and flesh residues are not freely flung around the mandrel, but kept inside the scraping unit. The scraped off material is removed without the scraped off material being wasted down upon e.g. the motor system, where it may imply bad hygiene or technical problems at the apparatus itself.

In order to remove scraped off material from the scraping unit, a number of suction connections connected to a vacuum system are arranged in connection with the protective jacket, so that scraped off material is collected in a funnel-like outlet ending in the suction connection and is sucked away.

The scraping unit is designed so that it starts with an upper pointed end of the mandrel, after which the scraping unit is moved down along the mandrel, and so that the rotation of the scraping rollers follows the direction of movement. This causes the scraped off material to be scraped downwards and out into the collecting funnels.

When the furs have been scraped on the flesh side, the furs are to be finished on the hair side, so that residual material does not occur here either that may cause ruining of the furs in the succeeding process so that they cannot be sold on a fur auction.

One of the actions that may be done after scraping is cleaning the fur, whereby the processing position includes at least one cleaning unit that includes a cleaning chamber with a number of brushes, a supply of sawdust and a suction opening for removal of sawdust containing residual fat.

The brushes may either be roller brushes or brush bands provided in the cleaning unit, so that they during use enclose the mandrel so that the brushes may treat the entire inner side of the fur at once, e.g. when the cleaning unit with roller brushes, just as the scraping apparatus, is moved from a pointed end of the mandrel and downwards along the mandrel, or by the band brush having a length providing entire fur to be brushed at once.

In order to remove residual fat, the cleaning apparatus is supplied sawdust, which absorbs residual fat, simultaneously with the brushing action.

Like the scraping unit, the cleaning unit is designed with a protective jacket in which there are suction openings so that the residual fat containing sawdust is sucked away from the mandrel by means of vacuum. This will provide that there will be no sawdust or the like falling down on the motor system, thereby causing hygienic problems or technical problems.

A third fur treating process is performed in a further processing position, where instead of manual processing at the taking off and turning of the furs, at least one combined removing and turning unit is used, including a holding means for a pointed end of the fur and a suction chamber for simultaneous turning of the fur.

Automatic removal and turning of the fur reduces the use of personnel for the fur processing, so that the personnel to be used for the apparatus is only to provide for mounting furs and possibly collect the dismounted and turned furs.

For automatic removal and turning furs in a process, the unit includes a holding means on a pointed end of the fur.

This holding means may e.g. be a gripper that gets hold of the nose part of the fur and thereby secures the fur on the mandrel at a fixed point, after which a suction chamber is passed down around the mandrel, and by means of vacuum the fur is sucked free and off the mandrel. When suction chamber is moved upwards, the fur is turned and may be placed in a container or box for collecting for further treatment or mounting on a pelting board.

The holding means may either be incorporated in the mandrel, so that it comes from outside the mandrel and gets hold of the nose part of the fur, or it may be a part of the suction chamber that comes down and holds the nose part, while the suction chamber sucks itself onto the inner side of the fur for turning the fur.

In an embodiment, the holding means is connected with the mandrel with a spring means, whereby the holding means may be moved in the longitudinal direction of the mandrel.

When a fur is pulled on the mandrel, the holding means will be pressed down on the pointed end of the mandrel during the scraping process so that the spring means is held compressed, whereby the fur may be pulled further down on the mandrel.

When the scraping process is finished, the spring means is released, so that the holding means is released and the pointed end of the mandrel is again allowed to be lifted between 10-15 min up the mandrel, so that the fur is thereby moved up the mandrel. This contributes to loosening the fur from the mandrel and to pull the fur free from the fillet of fat formed on the mandrel in the area right under the fur. The spring means may be released by an automatic or manual trigger which may be provided in connection with the ring-shaped surface.

For further reducing the need for personnel, and for reducing the transport of the fur from process to process, the said processing position, where removal and turning of the fur is effected, is designed so that the processing position furthermore includes a pelting unit for mounting the fur directly on a pelting board.

This means, that when the suction chamber is about to suck the fur off the mandrel, there will be a pelting unit placing a pelting board inside the suction chamber, so that the suction chamber pulls the fur up on the pelting board.

When the fur has been mounted on the pelting board, the holding means is released around the pointed end of the fur, and the pelting unit may insert a pelting board whereby the fur is automatically mounted correctly on the pelting board.

In order to ensure that the inner side of the fur is scraped completely clean by means of a set of scraping rollers that are placed in the scraping unit, the mandrels are designed with a doubly convex, lentiform cross-section that decreases upwards along the mandrel.

The double-convex, lentiform cross-section of the mandrels provides that the fur, which faces outwards with the inner side, in reality only has two sides to be scraped, there will only be two edge areas of the convex lentiform mandrel, which edge areas will be minimal whereby an optimal scraping is ensured.

As the mandrels are no longer four-edged, but have a double-convex, lentiform cross-section, the scraping rollers are designed with a concave scraping side which is designed complementary to the said cross-section of the mandrel, and have a width which is slightly greater than the greatest width of the mandrels.

This implies that the concave scraping side, irrespectively if it is in an initial position at a pointed end of the mandrel, or if it is moved down along the mandrel, it will always have close contact with the convex, lentiform cross-section of the mandrel, so that there are no spots on the outward facing inner side of the fur which are not properly scraped.

In order to ensure that the entire fur is scraped optimally, and that marking of the edge area of the convex, lentiform cross-section of the mandrel does not occur, the two scraping rollers are, the concave scraping sides of which enveloping the mandrel, and where the scraping rollers are mutually displaced along the mandrel, so that when the first scraping roller is put against the inner side of the fur, it will pull in the fur so that the edge area is pulled a little in on the side of the mandrel on which the scraping roller is running.

The subsequent scraping roller, which is opposite and displaced in relation to the first scraping roller, will draw the edge areas back past the edge of the convex lentiform shape, so that the edge area will be pulled round on the opposite side and be scraped clean. There will be a minimal edge area where double scraping possibly occurs.

A further processing position may include at least one cleaning unit for supplementing cleaning of the mandrels. When the scraping of the inner side of the fur is performed, fat and flesh residues will automatically be pushed down towards the bottom of the mandrel, which is a drawback clearly predominant on prior art apparatuses, where the mandrel is disposed in horizontal position.

With an apparatus where the mandrels, like in the present invention, are in upright position, there will also occur a carrying along of fat and flesh residues down towards the bottom part of the mandrels, smearing the mandrels over an area.

In order to avoid this, the cleaning unit is moved farther down than the scraping unit, so that brushing and sawdust treatments will clean the area where fat deposits from the scraping process are present.

If this is not enough, one of the processing positions may include a cleaning apparatus where the mandrel is washed from top to bottom, so that it will be completely clean when arriving at the first processing position where mounting of fur occurs.

Such a cleaning apparatus may be mounted with nozzles so that the mandrels are flushed clean, or it may be mounted with a new set of brushes which by means of a liquid wash the mandrels clean.

There are may different types of furs, depending on the place in the world the fur-bearing animal have grown up. It is therefor necessary that the scraping rollers are designed with different types and different degrees of hardness of scraping lamellae.

In order to provide for the different types of fur-bearing animals and the degree of hardness in scraping, the scraping roller is designed with recessed grooves for accommodating exchangeable scraping lamellae.

This entails that it is possible to replace the scraping lamellae, so that for fur-bearing animals that are to have a light treatment, one may use scraping lamellae with a hardness of only Shore 80, whereas the scraping lamellae in the scraping roller may be replaced rapidly so that the same scraping roller can be used with scraping lamellae with a Shore 87 for a more rough treatment of another type of fur.

The hardness of the scraping lamella may e.g. go from between 80 to 87 Shore, which is normal, but it is not unthinkable to use scraping lamellae that have Shore hardness outside this interval for furs which either are to have a very fine and light treatment or to have a more rough scraping.

In order not to be destroyed by repeated use, the mandrels are to be made of a material which is harder than the scraping lamellae. In a preferred embodiment, the mandrels are made in a plastic material that has a Shore value of about 95, or the mandrels are made of metal. It is ensured hereby that the scraping lamellae or the scraping rollers, when running down a mandrel, are capable of yielding so that the mandrels are not damaged.

In an embodiment, the respective longitudinal side edges of an insertion opening for the recessed opening to the recessed groove are designed with preferably different rounding radii.

By having different rounding radii on the longitudinal side edges of an insertion opening for the recessed groove, one may have two different scraping gradings by turning the scraping roller.

If e.g. there is a very large rounding radius, the scraping lamella will bend more and follow the surface of the scraping roller, and this will provide a finer scraping, while a small rounding radius on the side edge will cause the scraping lamella to be forced to a more upright radial position providing that the scraping lamella gets more hold, and the scraping thereby becomes coarser.

The scraping of the fur may be done as desired, because, besides enabling change of scraping lamellae and turning the scraping roller, one may operate with a variable rotational speed so that e.g. the scraping rollers are rotating differently.

As the apparatus now includes all these different units, such as a scraping unit, a cleaning unit and a combined removal and turning unit, it is not without consequence in which sequence these fur treatments occur. By the present invention there is therefore provided a method for processing furs by means of the apparatus.

The method includes the following method steps:
A fur is placed on a mandrel with a flesh side facing outwards in a preferably first processing position.
A motor system moves the mandrel to another processing position.
The scraping unit is lowered down over the mandrel and is moved downwards along the outer side of the fur disposed thereon, whereby remains of fat and flesh are scraped off.
The motor system moves the mandrel further to a third processing position where the cleaning unit is lowered down on the mandrel and is moved downwards along its outer side, whereby the fur is cleaned and sawdust with residual fat is sucked away.
The motor system moves the mandrel on to a fourth processing position where the combined removing and turning unit holds a pointed end of the fur while a suction chamber simultaneously provides for turning the fur.
The motor system moves the mandrel on to a next processing position, preferably the first processing position.

There may be up to several persons at the first processing position who put furs on the mandrels. This entails that it is not the manual mounting of furs that determines the capacity of the apparatus.

When the mandrels are mounted with a fur, the motor system moves from processing position to processing position, so that the first thing which happens is that the scraping unit scrapes the mandrel, after which the cleaning unit is lowered down over the mandrel, and finally comes the removing and turning unit.

The motor system moves the mandrel either at a continuous slow speed or in steps, so that the mandrels are gradually advanced.

By following the above method, it will be possible that there is a mandrel at each processing position so that it is a continuous process made by the apparatus.

If the motor system is running continuously at a slow speed, all the connected units are to be suspended so that they may be carried over a length. This puts demands on how the units are suspended as they are not only to have a vertical movement, but are also to have a horizontal movement.

In order to reduce the time with which the fur is to be treated by humans, the method is further specified so that the processing position with the combined removing and turning unit further includes a pelting board unit on which furs are mounted directly on a pelting board.

As previously mentioned, this method will imply that there will be no transporting between the removing and turning unit and the pelting board unit, providing that human action is not required, and furthermore it will be an advantage to have automatic pelting board mounting, as this is a demanding piece of work.

Between the processing position of the removing and turning unit and the processing position at which a new fur is mounted, there may be other processing positions, as e.g. where the motor system moves the mandrel on from the processing position with the combined removing and turning unit to a next processing position, where the cleaning unit performs a supplementing cleaning of the mandrel.

In that way it will be possible that the mandrels are always clean when they reach the fur mounting, and such a cleaning unit is always to be located after the removing and turning unit because it is only the mandrels that are to be cleaned.

Such a cleaning unit may possibly be designed so that it only cleans the lower part of the mandrel, as in principle there will be no fat deposits or the like on the upper part of the mandrels.

In an alternative embodiment of the whole invention, i.e. the apparatus and its method, the apparatus may be designed so that between each processing position there is spacing where e.g. a transport chain may bring the mandrels from one processing position to the next processing position.

This means that different processing positions do not need to be in immediate physical vicinity of each other so that it may now be allowed that the mounting of furs occurs in the room where the fur-bearing animals are skinned, while the scraping occurs in the adjacent room, and while the cleaning of the fur and removal and turning of furs and possibly mounting on pelting boards are effected in a third room.

To arrange the apparatus in that way may be an advantage, as the process may hereby be subdivided due to hygiene/smell/nuisances.

In that way it will furthermore also be possible to have mounted a number of mandrels on the motor system so that there may be up to 100-200 mandrels in one apparatus, implying that it will be the speed of the scraping process, the cleaning process and subsequent removal and turning which will be limiting to the capacity of the apparatus.

If one of these processes consumes much less time than the other processes, it may be feasible with such a system where there is a conveyor chain for moving the mandrels to an apparatus where, instead of only a scraping unit, there are provided two scraping units, and subsequently there may then be three or four cleaning units which will increase the capacity of the apparatus.

In a further, alternative embodiment of the invention, the apparatus may be designed so that the motor system consists of a conveyor chain, whereby it will be possible that the motor system consists of mandrels with fixing means moving around by means of small wheels in a rail/a guide, so that it is only at the process locations that the apparatus provides securing of the mandrels.

This implies that e.g. in front of each single processing position there is a buffer section with mandrels waiting to be processed, why a single processing station is provided with a gripper device that grips fixing means for the mandrels down in the rail/guide and moves them on the processing unit which is to treat the fur, after which the mandrel is moved on, out of the processing position and into a waiting position for the next processing position. In that way it is ensured that there is always 100% utilisation of the different processing positions.

Such an apparatus will, however, furthermore be designed with a platform-like unit on which up to several persons mounting furs may stand.

### SHORT DESCRIPTION OF THE DRAWING

The invention is explained in more detail in the following with reference to the drawing in which:

FIG. 1 shows a perspective view of an embodiment of an apparatus according to the invention,

FIG. 2 shows a plane view of the apparatus shown in FIG. 1;

FIG. 3 shows a detail of an embodiment of a scraping unit according to the invention;

FIG. 4 shows a sectional view through a scraping roller with a scraper lamella for a scraping unit for an apparatus according to the invention; and

FIG. 5 shows an alternative embodiment of an apparatus according to the invention.

### DETAILED DESCRIPTION OF THE INVENTION

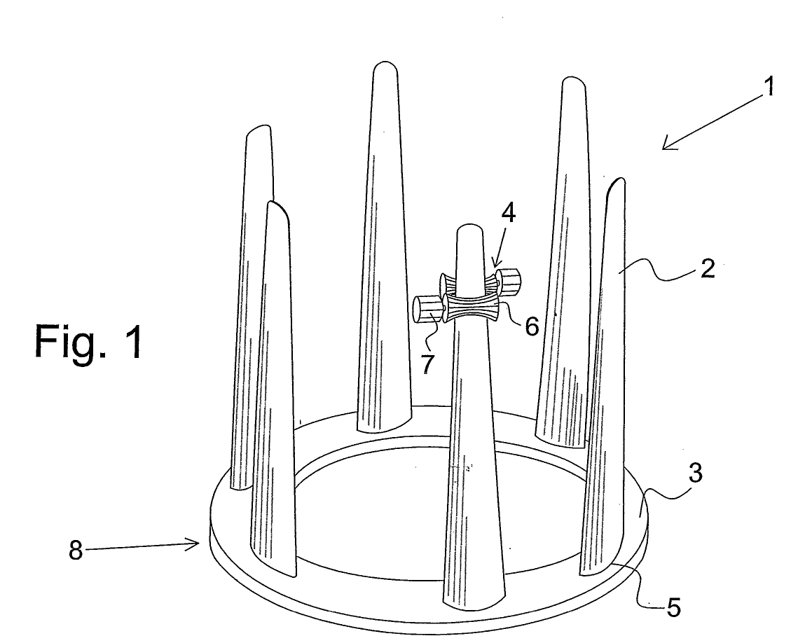

On FIG. 1 is here shown an apparatus 1 which comprises a motor system 8 in the form of a ring-shaped plate 3 on which is mounted a number of fixing means 5, which are adapted for holding the mandrels 2 in an upright position.

On one of the mandrels 2 there is shown a scraping unit 4 that consists of two scraping rollers 6 which are motor-driven by means of the motor units 7 and are disposed at each their side of mandrel 2 during operation and mutually displaced so that it is possible to achieve a complete scraping treatment of the fur.

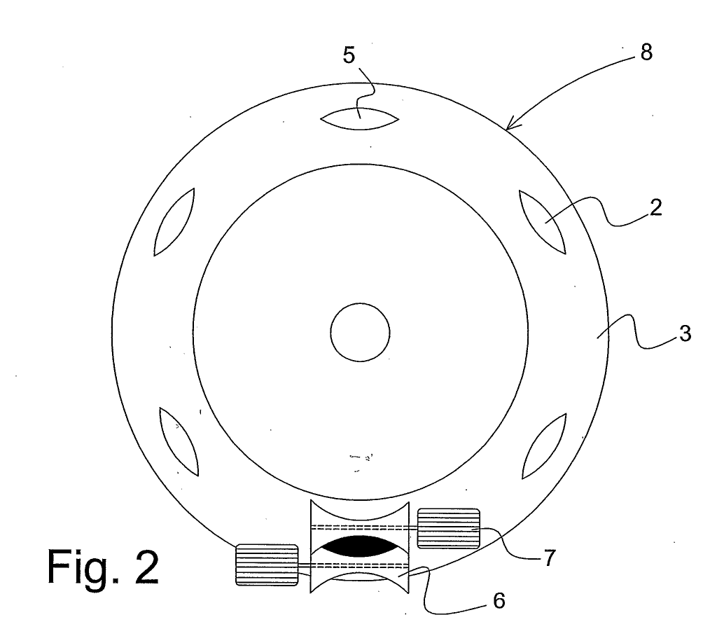

On FIG. 2 is shown a plan view of an apparatus 1 on which is seen that the motor system 8 consists of a ring-shaped unit 3, on which there is provided a number of fixing means 5 that enables fastening the mandrels 2 to the ring-shaped surface 3 in an upright position.

The apparatus 1 is only shown with the scraping unit 4 in a processing position where the scraping rollers 6 are lowered over a mandrel so that they enclose the mandrel 2.

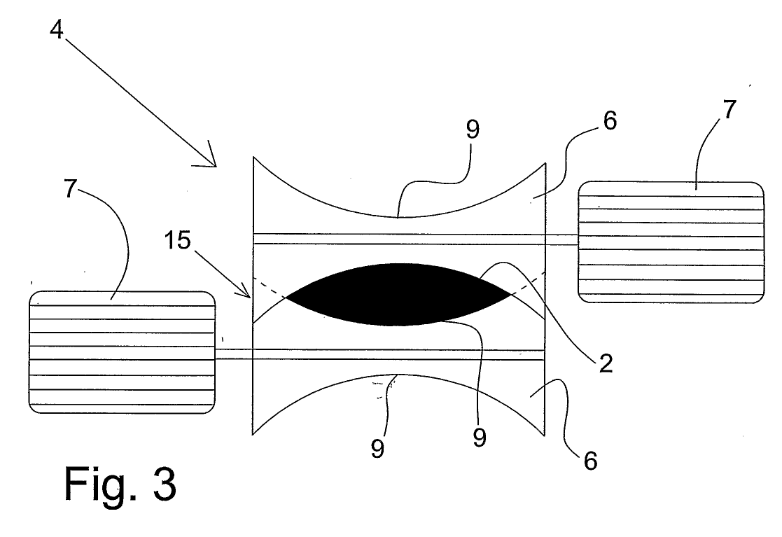

On FIG. 3 is shown how the scraping unit 4 is provided with two scraping rollers 6 that have concave scraping sides 9, which when the scraping unit 4 is in operation, will enclose the convex lentiform cross-section of the mandrel 2. The scraping unit 4 is shown with a motor 7 for each scraping roller 6, but it may alternatively be designed so that there is one motor 7 for both scraping rollers 6 which via a gearing provides for correct rotation of the scraping rollers 6. Alternatively, the motors 7 could be disposed at one side instead of being disposed at both sides.

The area 15 is the area where the scraping rollers 6 overlap each other, whereby it is ensured that the fur, which is mounted on mandrel 2, will be scraped clean on the entire flesh side.

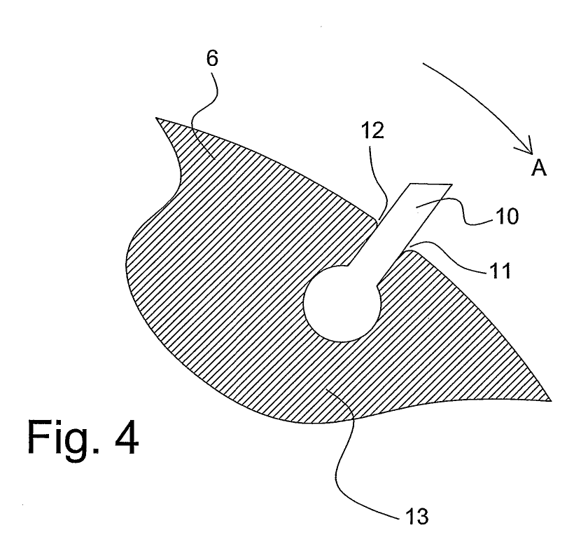

On FIG. 4 is shown a cross-section of a scraping roller 6 where it appears how a scraping lamella 10 is disposed in a recessed groove 13 so that scraping lamella 10 is secured in the groove 13 when scraping roller 6 is rotated, e.g. in direction of rotation A. Scraping lamella 10 is exchangeably mounted in the recessed groove 13.

The rounding radii for the side edges 11, 12 are different, implying that if the direction of rotation is A for the scraping rollers 6, the scraping lamella 10 will be braced against rounding radius 12, so that the scraping lamella 10 will have a very upright position, and there will hereby be effected a harder scraping of the fur.

If the direction of rotation, however, is opposite direction A, the scraping lamella 10 will lay down against the rounding radius 11 and thereby be forced a little more rearwards with the scraping, and there will be effected a not so hard scraping.

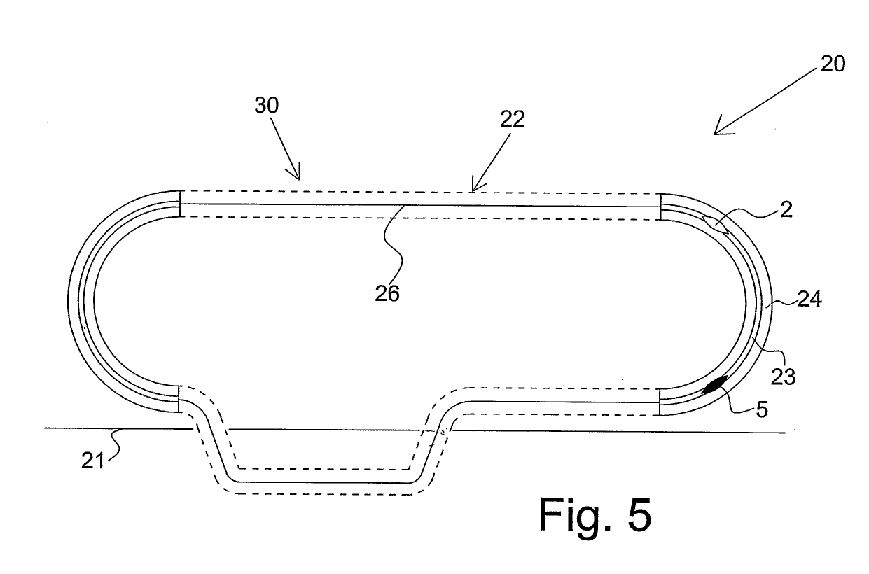

On FIG. 5 is seen an alternative embodiment of the invention, where an apparatus 20 is shown comprising rails 24 with an upwards facing opening 23 in which the motor system 22, here in the shape of a chain 26, is provided, where on the chain 26 there is disposed a number of fixing means 5 securing mandrels 2.

Here is shown an apparatus 20 in such an embodiment that in the rails 24 there is end station, and where along one long side 30 there is space for several persons standing and mounting furs on mandrels 25. Furthermore, there is a possibility that the rails 24 are let in through a wall 21, so that one of the processing positions possibly could be in another room where the rest of the apparatus 20 is located.

1-18. (canceled)

19. An apparatus for processing fur, including mandrels and at least one motor-driven scraping roller, where the fur is disposed on the mandrels with a flesh side facing outwards, comprising:
a motor system with fixing means for holding a lower end part of the mandrels which are disposed at an upright angle relative to the fixing means, wherein the motor system moves the mandrels past processing positions.

20. An apparatus according to claim 19, wherein the motor system includes a rotatable, ring-shaped surface, on which a number of the fixing means are provided.

21. An apparatus according to claim 19, wherein the motor system includes a conveyor chain on which a number of the fixing means are provided.

22. An apparatus according to claim 19, wherein the mandrels are fastened rotatably to the fixing means.

23. An apparatus according to claim 20, wherein the mandrels are fastened rotatably to the fixing means.

24. An apparatus according to claim 21, wherein the mandrels are fastened rotatably to the fixing means.

25. An apparatus according to claim 19, wherein the processing positions include at least one scraping unit with scraping rollers.

26. An apparatus according to claim 19, wherein the processing positions include at least one cleaning unit that includes a cleaning chamber with brushes, a supply of sawdust and a suction opening for removal of sawdust containing residual fat.

27. An apparatus according to claim 19, wherein the processing positions include at least one combined removing and turning unit that includes a holding means for a pointed end of the fur and a suction chamber for simultaneous turning of the fur.

28. An apparatus according to claim 27, wherein the holding means is connected with the mandrel with a spring.

29. An apparatus according to claim 27, wherein the processing position includes a pelting board unit for mounting the fur on a pelting board.

30. An apparatus according to claim 19, wherein the mandrels include a double-convex, lentiform cross-section decreasing upwardly along the mandrel.

31. An apparatus according to claim 19, wherein the scraping rollers include a concave scraping side which is shaped complementary to the cross-section of the mandrel.

32. An apparatus according to claim 30, wherein the scraping rollers include a concave scraping side which is shaped complementary to the cross-section of the mandrel.

33. An apparatus according to claim 19 including two scraping rollers, with concave scraping sides which envelope the mandrel, and the scraping rollers are mutually displaced along the mandrel.

34. An apparatus according to claim 31 including two scraping rollers, with concave scraping sides which envelope the mandrel, and the scraping rollers are mutually displaced along the mandrel.

35. An apparatus according to claim 19, wherein the processing positions include at least one cleaning unit for supplementary cleaning of the mandrels.

36. An apparatus according to claim 19, wherein the scraping rollers include recessed grooves for accommodating exchangeable scraping lamellae.

37. An apparatus according to claim 19, including an insertion opening with longitudinal side edges for the recessed grooves with different rounding radii.

38. An apparatus according to claim 36, including an insertion opening with longitudinal side edges for the recessed grooves with different rounding radii.

39. A method for processing fur, including mandrels and processing positions, wherein a fur is placed on a mandrel with a flesh side facing outwards in a first processing position; a motor system moves the mandrel to a second procession position; the scraping unit is lowered down over the mandrel and is moved downwards along outer side thereof, whereby remains of fat and flesh are scraped off from the flesh side of the fur; the motor system moves the mandrel further to a third processing position where the cleaning unit is lowered down over the mandrel and is moved downwards along outer side thereof, whereby the fur is cleaned and sawdust with residual fat is sucked away; the motor system moves the mandrel further to a fourth processing position where a combined removing and turning unit holds a pointed end of the fur while a suction chamber simultaneously provides for turning the fur; and that the motor system moves the mandrel on to a next processing position.

40. A method in accordance with claim 39 wherein the next processing position is the first processing position.

41. A method according to claim 39, wherein the processing position with the combined removing and turning unit furthermore includes a pelting board unit where fur is mounted directly on a pelting board.

42. A method according to claim 39, wherein the motor system moves the mandrel on from the processing position with the combined removing and turning unit to the next processing position where the cleaning unit performs a supplementing cleaning of the mandrel.

43. A method according to claim 40, wherein the motor system moves the mandrel on from the processing position with the combined removing and turning unit to the next processing position where the cleaning unit performs a supplementing cleaning of the mandrel.

44. A method according to claim 41, wherein the motor system moves the mandrel on from the processing position with the combined removing and turning unit to the next processing position where the cleaning unit performs a supplementing cleaning of the mandrel.
